(19) United States
(12) Patent Application Publication
(10) Pub. No.: US 2008/0180361 A1
(43) Pub. Date: Jul. 31, 2008

(54) Gas excitation display apparatus for having doublescan performed therein

(76) Inventor: Seung-Hyun Son, Suwon-si (KR)

Correspondence Address: ROBERT E. BUSHNELL, 1522 K STREET NW, SUITE 300, WASHINGTON, DC, 20005-1202, US

(21) Appl. No.: 11/979,627

(22) Filed: Nov. 6, 2007

(30) Foreign Application Priority Data
Jan. 26, 2007 (KR) 10-2007-0008563

(51) Int. Cl. G09G 3/28

(52) U.S. Cl. 345/60

(57) ABSTRACT

Provided is a gas excitation display apparatus having a gas excitation display panel and a driving apparatus. In the gas excitation display panel, a gas is excited by electrons emitted from electron emitters, ultraviolet rays are generated from the excited gas and excite phosphor cells, the phosphor cells emit visible light. Each horizontal driving period comprises a horizontal display time and a blanking time. In the horizontal display time, electrons are emitted from the electron emitters by a first electric field and then the emitted electrons return to the electron emitters by a second electric field that is formed in the opposite direction of the first electric field.

### CLAIM OF PRIORITY

This application makes reference to, incorporates the same herein, and claims all benefits accruing under 35 U.S.C. §119 from an application for GAS EXCITATION DISPLAY APPARATUS FOR HAVING DOUBLES CAN PERFORMED THEREIN earlier filed in the Korean Intellectual Property Office on the 26^{th} of January 2007 and there duly assigned Serial No. 10-2007-0008563.

### BACKGROUND OF THE INVENTION

1. Field of the Invention

The present invention relates to a gas excitation display apparatus that includes a gas excitation display panel and a driving apparatus for driving the gas excitation display panel, and more particularly, a gas excitation display apparatus in which an excitation gas is excited by electrons emitted from electron emitters and the flow of electrons is controlled by driving signals supplied from the driving apparatus.

2. Description of the Related Art

In a typical discharge display apparatus, for example, the plasma display apparatus disclosed in U.S. Pat. No. 6,903,709, a gas is ionized by a gas discharge process that required high voltage, and the ionized gas enters an excited state. When the excited gas stabilizes, ultraviolet rays are generated. The ultraviolet rays excite phosphor materials formed in discharge cells to emit visible light.

In a discharge display apparatus such as the plasma display apparatus, a discharge process for ionizing a gas is necessary. However, the discharge process requires a large driving power.

### SUMMARY OF THE INVENTION

The present invention provides a display apparatus that is capable of displaying images without generating gas discharge that requires high driving power. The display apparatus of the present invention is driven by the use of gas excitation phenomenon, and therefore requires low driving power.

According to an aspect of the present invention, there is provided a gas excitation display apparatus having a gas excitation display panel and a driving apparatus for driving the gas excitation display panel. The gas excitation display apparatus includes a front panel, a rear panel facing the front panel, an excitation gas filled in a space between the front panel and the rear panel, a plurality of phosphor cells formed between the front panel and the rear panel, and a plurality of electron emitters for emitting electrons in response to driving signals applied to the gas excitation display panel from the driving apparatus. The excitation gas is excited by electrons emitted from electron emitters. Ultraviolet rays are generated from the excited gas and excite the phosphor cells. The phosphor cells emit visible light. Each of the driving signals includes a horizontal display time period and a blanking time period. The horizontal display time period further includes a first time period and a second time period. A first electric field for emitting electrons is formed in the space between the front panel and the rear panel during the first time period, and a second electric field for returning the electrons to the electron emitters is formed in the space between the front panel and the rear panel during the second time period. The second electric field is formed in an opposite direction of the first electric field.

In the horizontal display time, without generating gas discharge, the gas may be excited by the emitted electrons. Accordingly, a discharge display apparatus displays an image with low driving power.

In the horizontal display time, electrons emitted by the first electric field primarily excites the gas and then electrons accumulated in the cells of the phosphor lines secondarily excite the gas by the second electric field, and the electrons return to the electron emitters. Accordingly, the electrons are not accumulated in the phosphor cells and simultaneously a double-scan effect is obtained, so that performance and efficiency of overall operation of a gas excitation display apparatus improve.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view illustrating a structure of a gas excitation display panel constructed as an embodiment of the present invention;

FIG. 2 is a block diagram illustrating a driving apparatus for driving the gas excitation display panel of FIG. 1, which is constructed as an embodiment of the present invention;

FIG. 3 is a diagram illustrating driving signals generated from the driving apparatus of FIG. 2, which is constructed as an embodiment of the present invention;

FIG. 4 is a diagram illustrating driving signals generated from the driving apparatus of FIG. 2, which is constructed as an embodiment of the present invention;

FIG. 5 is an exploded perspective view illustrating a structure of a gas excitation display panel constructed as another embodiment of the present invention; and

FIG. 6 is a diagram illustrating driving signals generated to drive the gas excitation display panel of FIG. 5, which is constructed as an embodiment of the present invention.

### DETAILED DESCRIPTION OF THE INVENTION

The present invention will now be described more fully with reference to the accompanying drawings in which exemplary embodiments of the invention are shown.

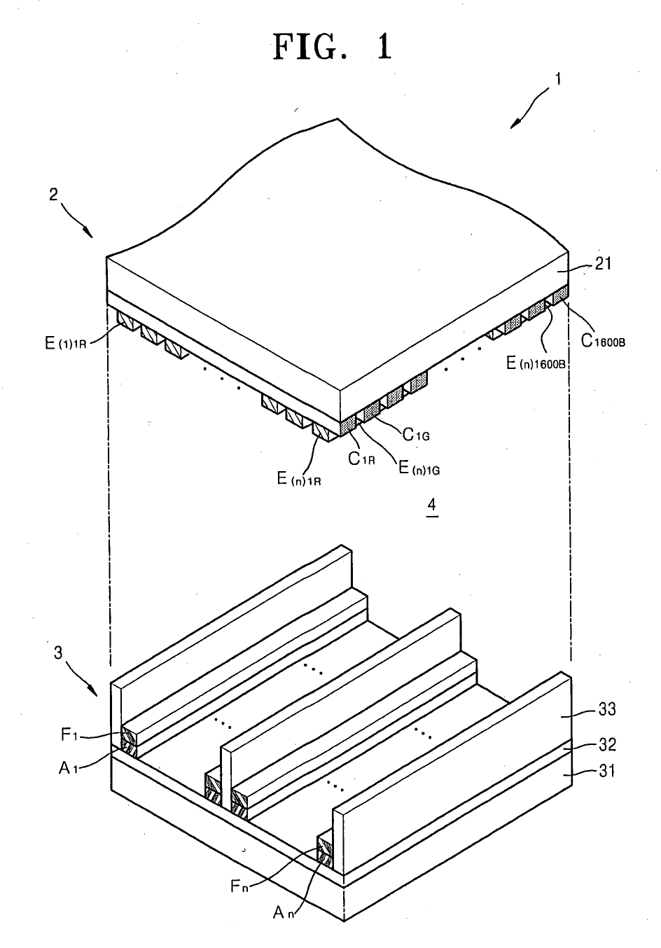

FIG. 1 is an exploded perspective view illustrating a structure of a gas excitation display panel 1 constructed as an embodiment of the present invention. Referring to FIG. 1, in the gas excitation display panel 1, excitation gas 4 is sealed between a front panel 2 and a rear panel 3. The excitation gas 4 may be an Xe gas or at least one of a gas such as N₂, D₂, CO₂, H2, CO, Kr, or air mixed in the Xe gas.

Barrier ribs 33 are formed between the front panel 2 and the rear panel 3 to partition the space between the front panel 2 and the rear panel 3 into discharge cells. Anode electrode lines A₁, . . . , Aₙ, which are scan electrode lines, are formed between two of the barrier ribs 33. Accordingly, interference between adjacent discharge cells can be prevented by the barrier ribs 33. In FIG. 1, it is shown that two anode electrode lines are formed between two of the barrier ribs 33, but the number of anode electrode lines formed between two of the barrier ribs 33 is not limited to two but can have any number.

The rear panel 3 includes a rear substrate 31, a reflection plate 32 to reflect visible light, barrier ribs 33, the anode electrode lines A₁, . . . , Aₙ as scan electrode lines, and phosphor lines F₁, . . . , Fₙ. The phosphor lines F₁, . . . , Fₙ are formed on the top of the anode electrode lines A₁, . . . , Aₙ, and thus are connected to the anode electrode lines.

The front panel 2 includes a front transparent substrate 21, cathode electrode lines C_{1R}, . . . C_{1600B} as data electrode lines, and electron emitters E_{(1)1R}, . . . , E_{(n)1600B}. The cathode electrode lines C_{1R}, . . . , C_{1600B}, to which data signals are applied, are electrically connected to the electron emitters E_{(1)1R}, . . . , E_{(n)1600B}. The electron emitters E_{(1)1R}, . . . , E_{(n)1600B} are formed of oxidized porous poly-silicon (OPS) or carbon nanotubes (CNT).

An operation of the gas excitation display panel 1 will now be described. Electrons are emitted from the electron emitters E_{(1)1R}, . . . , E_{(n)1600B}. Gas 4 is excited by the emitted electrons. Ultraviolet rays are generated while the excited gas 4 stabilizes. The ultraviolet rays excite the phosphor lines F₁, . . . , Fₙ, and thus visible light is emitted from the phosphor lines.

That is, without generating a gas discharge, the gas 4 can be excited using the emitted electrons. Accordingly, a discharge display apparatus of the present invention can display an image with low driving power.

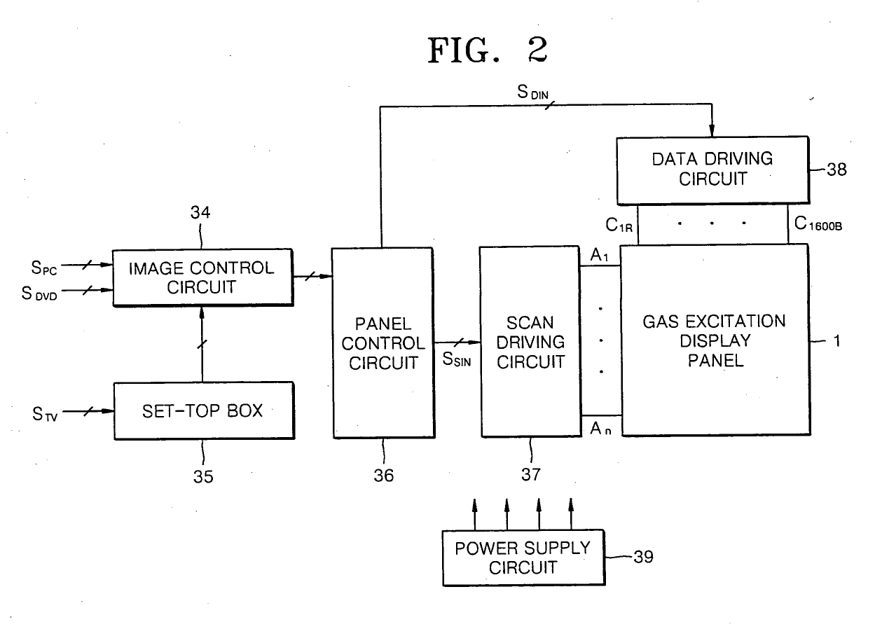

FIG. 2 is a block diagram illustrating a driving apparatus of the gas excitation for driving the display panel of FIG. 1, according to an embodiment of the present invention. Referring to FIG. 2, the driving apparatus of the gas excitation display of the present invention includes an image control circuit 34, a set-top box 35, a panel control circuit 36, a scan driving circuit 37, a data driving circuit 38, and a power supply circuit 39.

The image control circuit 34 processes an image signal S_{PC} received from a computer, an image signal S_{DVD} received from a digital versatile disk (DVD), and an image signal received from the set-top box, and inputs the image signals to the panel control circuit 36. The set-top box 35 processes an image signal S_{TV} of a television and inputs the image signal S_{TV} to the image control circuit 34.

The panel control circuit 36 generates scan-drive control signals S_{SIN} and data-drive control signals S_{DIN} by processing the image signals received from the image control circuit 34. The scan driving circuit 37 drives the anode electrode lines A₁, . . . , Aₙ of the gas excitation display panel 1 in response to the scan-drive control signals S_{SIN} received from the panel control circuit 36.

The data driving circuit 38 drives the cathode electrode lines C_{1R}, . . . C_{1600B} of the gas excitation display panel 1 in response to the data-drive control signals S_{DIN} received from the panel control circuit 36.

While a scan pulse is sequentially applied to the anode electrode lines A₁, . . . , Aₙ which act as scan electrode lines, a negative polarity data pulse is applied to the cathode electrode lines C_{1R}, . . . , C_{1600B} which act as data electrode lines. Here, a grey scale display can be performed according to the electric potential of the negative polarity data pulse or applying time period of the data pulse.

The power supply circuit 39 supplies necessary electric potential to the image control circuit 34, the set-top box 35, the panel control circuit 36, the scan driving circuit 37, and the data driving circuit 38.

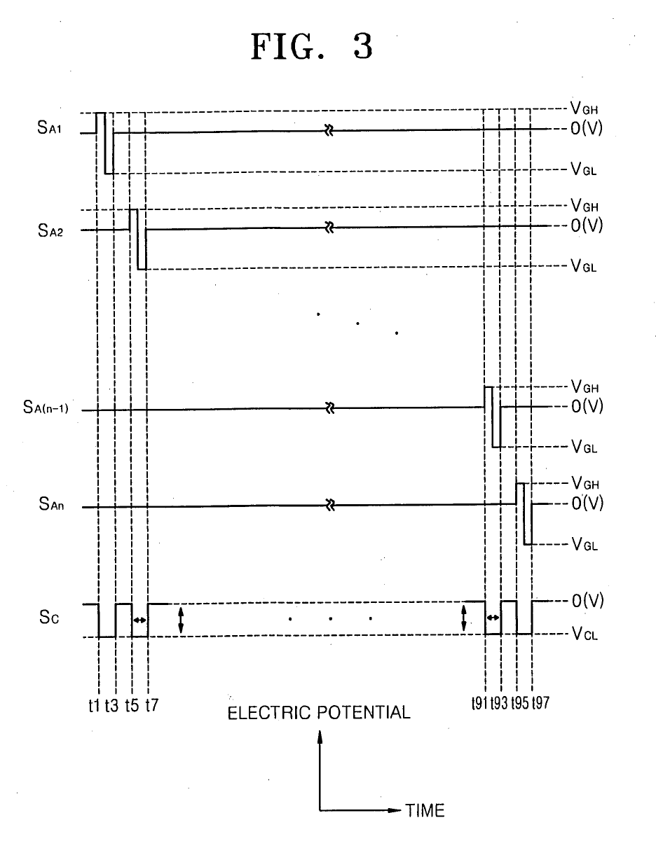

FIG. 3 is a diagram illustrating driving signals generated from the driving apparatus of FIG. 2, which is constructed as an embodiment of the present invention. In FIG. 3, S_{A1} through S_{An} indicate scan driving signals of the anode electrode lines A₁, . . . , Aₙ as scan electrode lines, and S_{C} indicates one of data driving signals applied to the cathode electrode lines C_{1R}, . . . , C_{1600B}.

An example of a driving signal generated by the driver of FIG. 2 will now be described with reference to FIGS. 1 through 3.

In a display period between time t1 and t97, a double scan pulse having a set of positive polarity electric potential V_{GH} and a negative polarity electric potential V_{GL} is sequentially applied to the anode electrode lines A₁, . . . , Aₙ, and negative polarity data pulses coinciding with the positive polarity scan pulse are applied to the cathode electrode lines C_{1R}, . . . , C_{1600B}. The magnitude of the electric potential V_{CL} and/or applying time of the negative polarity data pulses applied to the cathode electrode lines C_{1R}, . . . , C_{1600B} can vary to achieve grey scales.

Each of the horizontal driving periods (for example, between time t1 and t5) includes a horizontal display time period (for example, between time t1 and t3) and a blanking time period (for example, between time t3 and t5). The horizontal display time period includes a first time period, in which positive polarity electric potential V_{GH} is applied to the anode electrode lines, and a second time period, in which a negative polarity electric potential V_{GL} is applied to the anode electrode lines.

In each of the horizontal display time periods (for example, between time t1 and t3), the double scan pulse is applied to one of the anode electrode lines (for example, A₁) to be scanned. Therefore, electrons are emitted from the electron emitters E_{(1)1R}, . . . , E_{(n)1600B} by a first electric field, which is generated while voltage V_{GH} is applied to the anode electrode line A₁, during the horizontal display time period. The emitted electrons, then, return to the electron emitters E_{(1)1R}, . . . , E_{(n)1600B} by a second field, which is generated while voltage V_{GL} is applied to the anode electrode line A₁. The second electric field is applied in an opposite direction of the first electric field.

In this way, the electrons emitted by the first electric field primarily excite the gas 4, and then electrons accumulated around the phosphor lines F₁, . . . , Fₙ in the discharge cells secondarily excite the gas 4 by the second electric field and return to the electron emitters E_{(I)1R}, . . . , E_{(n)1600B}. Accordingly, the electrons are not accumulated in the phosphor cells, and simultaneously a double-scan effect is obtained. Therefore, performance and efficiency of overall operation of a gas excitation display apparatus improve.

A negative polarity electric potential V_{CL} is applied to the cathode electrode lines C_{1R}, . . . , C_{1600B} during the horizontal display time period (for example, between time t1 and t3).

As described above, a grey scale is realized by adjusting the magnitude of the electric potential V_{CL} or by adjusting the applying time of the negative polarity data pulse applied to the cathode electrode lines C_{1R}, . . . C_{1600B}.

As described above, in the horizontal display time period (for example, between time t1 and t3), electrons are emitted from the electron emitters E_{(1)1R}, . . . , E_{(n)1600B}. Then, the gas 4 is excited by the emitted electrons. While the excited gas 4 is stabilized, ultraviolet rays are generated, and the ultraviolet rays excite the phosphor lines F₁, . . . , Fₙ, in the discharge cells. Thus, the phosphor lines F_{(1)1R}, . . . F_{(n)1R} emit visible light.

That is, without generating gas discharge, gas 4 can be excited by the emitted electrons. Accordingly, a discharge display apparatus of the present invention can display an image with low driving power.

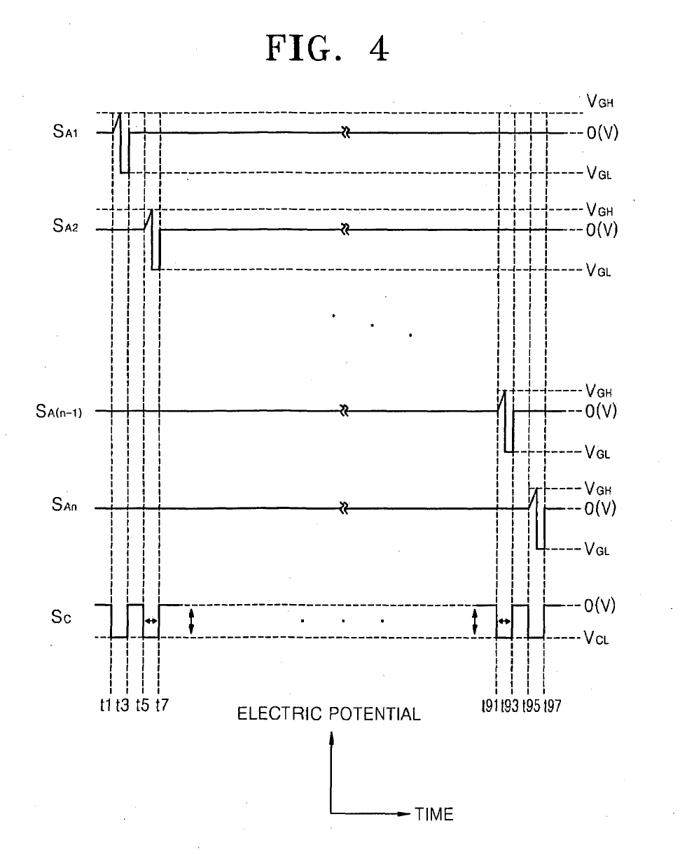

FIG. 4 is a diagram illustrating driving signals generated from the driving apparatus of FIG. 2, which is constructed as an embodiment of the present invention. In FIGS. 3 and 4, like reference numerals denote like elements having the same function, thus the detailed descriptions thereof will not be repeated. The difference in the diagram of FIG. 4 from the diagram of FIG. 3 is that a rising speed of a positive polarity electric potential applied to the anode electrode lines A₁, . . . , Aₙ in the first half of the horizontal display time period (for example, between time t1 and t3) is slower than a falling speed thereof. In other words, the electric potential of positive polarity slowly rises to the level of V_{GH} from 0 level, and fast falls to the level of V_{GL} from the level of V_{GH}. Accordingly, electrons can be emitted from the electron emitters E_{(1)1R}, . . . , E_{(n)1600B} in a more stable manner.

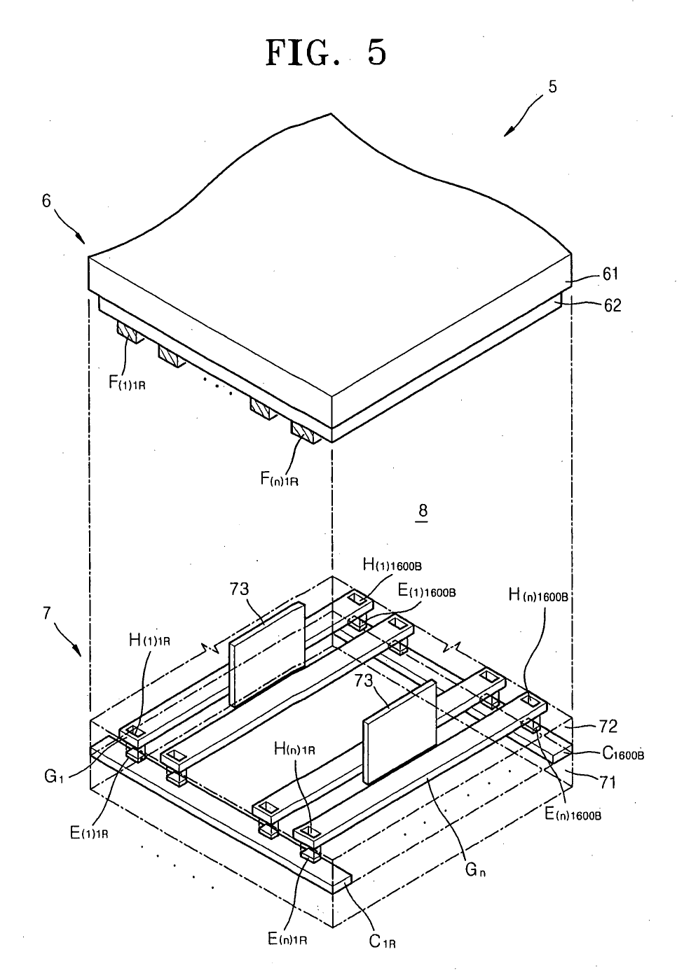

FIG. 5 is an exploded perspective view illustrating a structure of the gas excitation display panel constructed as another embodiment of the present invention. Referring to FIG. 5, in the gas excitation display panel 5, an excitation gas 8 is sealed between a front panel 6 and a rear panel 7. The excitation gas 8 may be an Xe gas or at least one of a gas such as N₂, D₂, CO₂, H2, CO, Kr, or air mixed in the Xe gas.

Barrier ribs 73 is formed between the front panel 6 and the rear panel 7 to partition the space between the front panel 6 and the rear panel 7 into discharge cells. Gate electrode lines G₁, . . . , Gₙ, are formed between the barrier ribs 73 as shown in FIG. 5. Accordingly, mutual interference between adjacent discharge cells can be prevented.

The rear panel 7 includes a rear substrate 71, the cathode electrode lines C_{1R}, . . . , C_{1600B} as data electrode lines, electron emitters E_{(1)1R}, . . . , E_{(n)1600B}, an insulating layer 72, and gate electrode lines G₁, . . . , Gₙ as scan electrode lines. The insulating layer 72 is formed to cover the cathode electrode lines C_{1R}, . . . , C_{1600B}, and the gate electrode lines G₁, . . . , Gₙ are formed on the insulating layer 72. Therefore, the insulating layer 72 prevent short-circuit between the gate electrode lines and cathode electrode lines. The gate electrode lines G₁, . . . , Gₙ cross the cathode electrode lines C_{1R}, . . . , C_{1600B}. The electron emitters E_{(1)1R}, . . . E_{(n)1600B} are formed on the cathode electrode lines C_{1R}, . . . , C_{1600B}.

The cathode electrode lines C_{1R}, . . . , C_{1600B}, to which data signals are applied, are electrically connected to the electron emitters E_{(1)1R}, . . . , E_{(n)1600B}. Tough-holes H_{(1)1R}, . . . , H_{(n)1600B}, are formed in an insulating layer 72 and the gate electrode lines G₁, . . . , Gₙ at positions that are matched with the positions of the electron emitters E_{(1)1R}, . . . , E_{(n)1600B}. That is, the through-holes H_{(1)1R}, . . . , H_{(n)1600B} are formed in the gate electrode lines G₁, . . . , Gₙ at the positions, on which the gate electrode lines G₁, . . . , Gₙ cross the cathode electrode lines C_{1R}, . . . , C_{1600B}. The electron emitters E_{(1)1R}, . . . , E_{(n)1600B} are formed of oxidized porous poly-silicon (OPS) and carbon nanotube (CNT).

The front panel 6 includes a front transparent substrate 61, an anode plate 62, and phosphor cells F_{(1)1R}, . . . , F_{(n)1R}. The phosphor cells F_{(n)1R}, . . . , F_{(n)1R} are formed corresponding to the through-holes H_{(1)1R}, . . . , H(n)_{1600B} which are formed in the gate electrode lines G₁, . . . , Gₙ.

An operation of the gas excitation display panel 5 will now be described.

Electrons are emitted from the electron emitters E_{(1)1R}, . . . , E_{(n)1600B}. The gas 8 is excited by the emitted electrons. Ultraviolet rays are generated while the excited gas 8 stabilizes. The ultraviolet rays excite the phosphor cells F_{(1)1R}, . . . , F_{(n)1R}, thus visible light is emitted. That is, without generating a gas discharge, the gas 8 can be excited using the emitted electrons. Accordingly, a discharge display apparatus can display an image with low driving power.

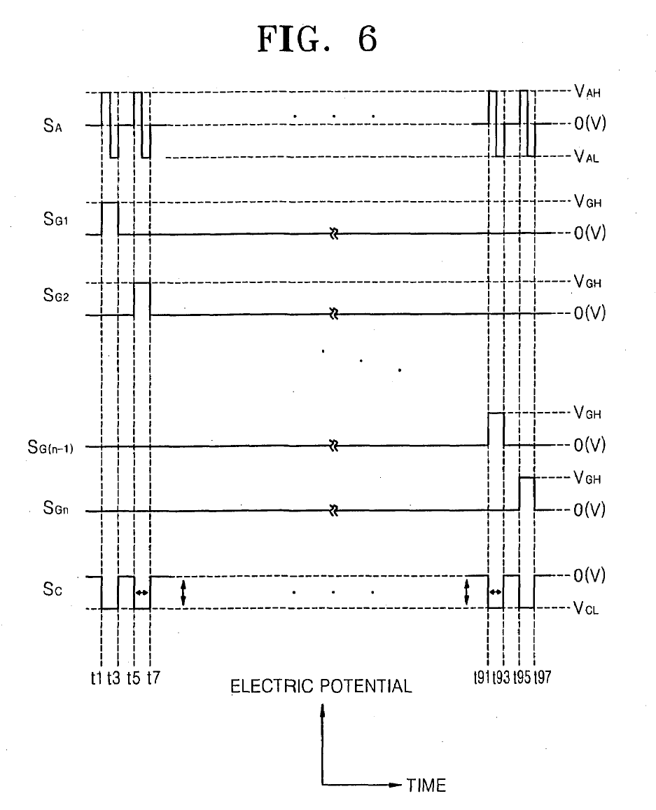

FIG. 6 is a diagram illustrating driving signals generated to drive the gas excitation display panel of FIG. 5, according to an embodiment of the present invention. In FIG. 6, S_{A} indicates a driving signal of the anode plate 62 shown in FIG. 5, S_{G1} indicates a driving signal applied to the first gate electrode line G₁ in FIG. 5, S_{G2} indicates a driving signal applied to the second gate electrode line G₂ in FIG. 5, S_{Gn} indicates a driving signal applied to the nth gate electrode line Gₙ in FIG. 5, and S_{C} indicates a driving signal applied to one of the cathode electrode lines C_{1R}, . . . , C_{1600B}.

An example of a driving signal generated by the driving apparatus of FIG. 2 will now be described with reference to FIGS. 5 and 6.

In a display period between time t1 to time t97, a positive polarity scan pulse having a set positive polarity electric potential V_{GH} and pulse width corresponding to the interval of time t1 to time t3 is sequentially applied to the gate electrode lines G₁, . . . , Gₙ, and negative polarity data pulses corresponding to the positive polarity scan pulse are applied to the cathode electrode lines C_{1R}, . . . , C_{1600B}. The magnitude of the electric potential V_{CL} and/or applying time of the negative polarity data pulses applied to the cathode electrode lines C_{1R}, . . . , C_{1600B} vary according to grey scales. For example, in order to achieve the highest gray scale level, a width T_{DPW} of a negative polarity data pulse having a maximum grey scale is the same as a width T_{HDR} of the positive polarity scan pulse. In order to achieve the lowest gray scale level, the width T_{DPW} of the negative polarity data pulse is 0, thus, an electric potential of 0 V is applied. In order to achieve a gray scale level between the highest and the lowest, the width T_{DPW} of the negative polarity data pulse has a pulse width between the width T_{HDR} of the positive polarity scan pulse and zero.

Each of the horizontal driving periods (for example, between time t1 and t5) includes a horizontal display time period (for example, between time t1 and t3) and a blanking time period (for example, between time t3 and t5).

In each of the horizontal display time periods (for example, between time t1 and t3), a double pulse having a positive polarity electric potential V_{AH} and a negative polarity electric potential V_{AL} is applied to the anode plate 62.

Therefore, electrons are emitted from the electron emitters E_{(1)1R}, . . . E_{(n)1600B} by a first electric field, which is generated during the application of the positive polarity electric potential V_{AH}, and then the emitted electrons return to the electron emitters E_{(1)1R}, . . . , E_{(n)1600B} by a second field, which is generated during the application of the negative polarity electric potential V_{AL} and is applied in an opposite direction of the first electric field.

In this way, the electrons emitted by the first electric field primarily excite the gas 8 and then electrons accumulated in the cells of the phosphor lines F₁, . . . , Fₙ secondarily excite the gas 8 by the second electric field, and return to the electron emitters E_{(1)1R}, . . . , E_{(n)1600B}. Accordingly, the electrons are not accumulated in the phosphor cells and simultaneously a double-scan effect is obtained, so that performance and efficiency of overall operation of a gas excitation display apparatus improve.

The electric potential V_{AL} of the anode plate 62 is 0 in each of the blanking time period (for example, between time t3 and t5).

The positive polarity electric potential V_{GH} is applied to the gate electrode line (for example, G₁) to be scanned in the horizontal display time period (for example, between time t1 and t3). In the blanking time period (for example, between time t3 and t5) following the horizontal display time period (for example, between time t1 and t3), zero electric potential 0V is applied to the gate electrode line (for example, G₁).

The negative polarity electric potential V_{AH} is applied to the cathode electrode lines C_{1R}, . . . , C_{1600B} in the horizontal display time period (for example, between time t1 and t3).

Also, zero electric potential 0V is applied to the cathode electrode lines C_{1R}, . . . , C_{1600B} in the blanking time period (for example, between time t3 and t5). As described above, a grey scale is realized by adjusting the magnitude of the electric potential V_{CL} or by adjusting applying time of the negative polarity data pulse applied to the cathode electrode lines C_{1R}, . . . , C_{1600B}.

As described above, in the horizontal display time period (for example, between time t1 and t3), while the double excited gas 8 is stabilized, ultraviolet rays are generated, and the ultraviolet rays excite the phosphor cells F_{(1)1R}, . . . , F_{(n)1R}. Thus, the phosphor cells F_{(1)1R}, . . . , F_{(n)1R} emit visible light. That is, without generating gas discharge, the gas 8 can be excited by the emitted electrons. Accordingly, a discharge display apparatus can display an image with low driving power.

As described above, in a gas excitation display apparatus according to the present invention, during a horizontal display time period, without generating gas discharge, a gas can be excited by emitted electrons. Accordingly, a discharge display apparatus can display an image with low driving power.

Also, in the horizontal display time period, electrons emitted by a first electric field primarily excite the gas and then electrons accumulated in phosphor cells secondarily excite the gas by a second electric field and return to the electron emitters E_{(1)1R}, . . . , E_{(n)1600B}. Accordingly, the electrons are not accumulated in the phosphor cells and simultaneously a double-scan effect is obtained, so that overall performance and efficiency of a gas excitation display apparatus can be improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A gas excitation display apparatus having a gas excitation display panel and a driving apparatus for driving the gas excitation display panel, the gas excitation display apparatus comprising:
a front panel;
a rear panel facing the front panel;
an excitation gas filled in a space between the front panel and the rear panel;
a plurality of phosphor cells formed between the front panel and the rear panel; and
a plurality of electron emitters formed between the front panel and the rear panel, the electron emitters emitting electrons in response to driving signals applied to the gas excitation display panel from the driving apparatus, the excitation gas being excited by electrons emitted from electron emitters, ultraviolet rays being generated from the excited gas and exciting the phosphor cells, the phosphor cells emitting visible light, each of the driving signals including a horizontal display time period and a blanking time period, the horizontal display time period further including a first time period and a second time period, a first electric field for emitting electrons being formed in the space between the front panel and the rear panel during the first time period, a second electric field for returning the electrons to the electron emitters being formed in the space between the front panel and the rear panel during the second time period, the second electric field being formed in an opposite direction of the first electric field.

2. A gas excitation display apparatus having a gas excitation display panel and a driving apparatus for driving the gas excitation display panel, the gas excitation display panel comprising:
a front panel;
a rear panel facing the front panel;
a plurality of data electrode lines formed between the front panel and the rear panel;
a plurality of scan electrode lines formed between the front panel and the rear panel, the scan electrode lines crossing the data electrode lines;
a plurality of phosphor lines formed between the front panel and the rear panel;
a plurality of electron emitters coupled to the data electrodes, the electron emitters emitting electrons in response to driving signals applied to the gas excitation display panel from the driving apparatus, each of the driving signals including a horizontal display time period and a blanking time period, the horizontal display time period further including a first time period and a second time period, a first electric field for emitting electrons being formed between the data electrode lines and the scan electrode lines during the first time period, a second electric field for returning the electrons to the electron emitters being formed between the data electrode lines and the scan electrode lines during the second time period, the second electric field being formed in an opposite direction of the first electric field; and
an excitation gas filled in a space between the front panel and the rear panel.

3. The gas excitation display apparatus of claim 2, wherein the data electrode lines are cathode electrode lines, each of the data electrode lines being electrically connected to one of the electron emitters.

4. The gas excitation display apparatus of claim 3, wherein a data electric potential with negative polarity is applied to the data electrode lines during the horizontal display time period.

5. The gas excitation display apparatus of claim 4, wherein, in the horizontal display time period, a grey scale is realized by adjusting the magnitude of the data electric potential with negative polarity applied to the data electrode lines or by adjusting the applying time of the data electric potential with negative polarity to the data electrode lines.

6. The gas excitation display apparatus of claim 2, wherein each of the scan electrode lines contacts one of the phosphor lines.

7. The gas excitation display apparatus of claim 6, wherein a first scan electric potential with positive polarity is applied to the scan electrode lines during the first time period of the horizontal display time period, and a second scan electric potential with negative polarity is applied to the scan electrode lines during the second time period of the horizontal display time period.

8. The gas excitation display apparatus of claim 7, wherein a rising speed of the first scan electric potential with positive polarity is slower than a falling speed of the first scan electric potential with positive polarity.

9. The gas excitation display apparatus of claim 4, further comprising a plurality of barrier ribs, each of the barrier ribs being formed between the scan electrode lines.

10. The gas excitation display apparatus of claim 9, wherein the electron emitters and the data electrode lines are formed on the front panel, a reflection plate to reflect visible light is formed on the rear panel, and the phosphor lines and the scan electrode lines are arranged on the reflection plate.

11. The gas excitation display apparatus of claim 2, wherein the electron emitters are formed of one of oxidized porous poly-silicon (OPS) and carbon nanotube (CNT).

12. A gas excitation display apparatus having a gas excitation display panel and a driver for driving the gas excitation display panel,
a front panel;
a rear panel facing the front panel;
a plurality of data electrode lines formed between the front panel and the rear panel;
an anode plate formed between the front panel and the rear panel;
a plurality of gate electrode lines formed between the data electrode lines and the anode plate, the gate electrode lines crossing the data electrode lines;
a plurality of phosphor cells formed between the front panel and the rear panel;
a plurality of electron emitters coupled to the data electrodes, the electron emitters emitting electrons in response to driving signals applied to the gas excitation display panel from the driving apparatus, each of the driving signals including a horizontal display time period and a blanking time period, the horizontal display time period further including a first time period and a second time period, a first electric field for emitting electrons being formed between the data electrode lines and the anode plate during the first time period, a second electric field for returning the electrons to the electron emitters being formed between the data electrode lines and the anode plate during the second time period, the second electric field being formed in an opposite direction of the first electric field; and
an excitation gas filled in a space between the front panel and the rear panel.

13. The gas excitation display apparatus of claim 12, wherein the data electrode lines are cathode electrode lines, each of the data electrode lines being electrically connected to one of the electron emitters.

14. The gas excitation display apparatus of claim 13, wherein each of the gate electrode lines has a through-hole that is formed at a position on which the gate electrode lines cross the data electrode lines, one of the electron emitters being formed on a position that is matched with the position of the through-hole.

15. The gas excitation display apparatus of claim 14, wherein, in the horizontal display time period, a gate electric potential with positive polarity is applied to the gate electrode lines, and a data electric potential with negative polarity is applied to the data electrode lines.

16. The gas excitation display apparatus of claim 15, wherein a first anode electric potential with positive polarity is applied to the anode plate during the first time period of the horizontal display time period, and a second anode electric potential with negative polarity is applied to the anode plate during the second time period of the horizontal display time period.

17. The gas excitation display apparatus of claim 16, wherein, in the horizontal display time period, a grey scale is realized by adjusting the magnitude of the data electric potential with negative polarity applied to the data electrode lines or by adjusting the applying time of the data electric potential with negative polarity to the data electrode lines.

18. The gas excitation display apparatus of claim 13, further comprising a plurality of barrier ribs, each of the barrier ribs being formed between the gate electrode lines.

19. The gas excitation display apparatus of claim 12, wherein the electron emitters are formed of one of oxidized porous poly-silicon (OPS) and carbon nanotube (CNT).

20. The gas excitation display apparatus of claim 12, wherein the phosphor cells are arranged on the anode plate.
